(19) United States
(12) Patent Application Publication
(10) Pub. No.: US 2010/0032089 A1
(43) Pub. Date: Feb. 11, 2010

(54) METHOD OF COATING WEB-FORM CARRIER MATERIALS WITH HIGH COATWEIGHT

(75) Inventors: Manfred SPIES, Bad Bramstedt (DE); Peter WEHRMANN, Freiburg (DE); Basir BAQI, Hamburg (DE); Ulrike SUTTER, Neuried (DE)

Correspondence Address: Hildebrand, Christa;Norris McLaughlin & Marcus PA, 875 Third Avenue, 8th Floor, New York, NY, 10022, US

(73) Assignee: TESA SE, HAMBURG (DE)

(21) Appl. No.: 12/509,948

(22) Filed: Jul. 27, 2009

(30) Foreign Application Priority Data
Aug. 8, 2008 (DE) 10 2008 036 926.8

(51) Int. Cl. B32B 38/00; B05D 3/02; B05D 5/10; C08F 2/54; B05D 3/06; C08F 2/48; B05D 1/36

(52) U.S. Cl. 156/273.3; 427/372.2; 427/207.1; 427/496; 427/379; 427/557; 427/535; 427/508; 427/208; 427/208.8

(57) ABSTRACT

Method of coating a web-form carrier material with an aqueously dispersed composition, the composition being applied to the carrier material with a suitable applicator with a coatweight of at least 10 g/m² (dry) and the subsequent drying of the coated carrier material taking place in a suspension drying unit.

### BACKGROUND OF THE INVENTION

(1) Field of the Invention

The invention relates to a method of coating a web-form carrier material with an aqueously dispersed composition.

(2) Description of Related Art

Pressure-sensitive adhesives (PSAs) or non-adhesive coatings are customarily applied as a 100% system, from solution or aqueously to the carrier materials in question.

Customary applicators for the coating of aqueous coats of relatively high viscosity are knife metering systems or coating bars with comma knife or coating blades. In the case of low-viscosity media, engraved-roll applicators, curtain coating or spray-nozzle coating can be employed. Customary applicators for 100% systems are roll or nozzle applicators.

A comprehensive description of known coating techniques is collated in D. Satas, Handbook of Pressure Sensitive Adhesive Technology, 1999, “Coating Equipment” chapter, page 896 ff.

On account of their viscosity behaviour, 100% systems can frequently be coated in high coat thicknesses with no problems at all.

In the case of water-based systems, the viscosity can be influenced via the solids content. In addition it is possible to raise the viscosity via added thickeners.

In the case of the solvent-based systems, there is a sharp rise in the drying time needed for the quantitative removal of the solvent. With the presently customary drying technology, the drying of solvent-based coats with a coatweight of more than 100 g/m² is not economically feasible. In addition, at high coatweights, there are not inconsiderable amounts of residual solvent remaining in the coating. The approach taken, therefore, is frequently to produce thick coats by operations of laminating individual thin coats.

The drying of aqueous and solvent-based coatings takes place customarily in coating units with downstream drying tunnels which allow the solvent or the water to be removed from the coating. The solvent removed is either regenerated or sent to an incinerator.

Through controlled adjustment of the temperatures in the drying tunnels it is possible to influence the degree of drying. Controlled drying is ultimately a prerequisite for the attainment of a flawless coating aspect and the quality of a coating free from water, solvent or low-volatility constituents. Customary drying units for solvent- or water-based coatings are designed with from about six to twelve drying zones, with a drying zone having a length of approximately one to three metres.

In the production of adhesive tapes, a web of base material drawn from a stock roll is coated with a water- or solvent-based adhesive, and this coated web is dried in a convection dryer. Convection dryers widely used are suspension dryers. Suspension dryers for coated material webs are units having a drying chamber, in which the coated material webs are placed, for drying, in large, downwardly hanging festoons via moving support rods made preferably of metal, which are conveyed slowly through the drying chamber by means of a circular conveyor, more particularly a chain conveyor. Drying takes place at moderate air velocities and under mild drying conditions. Depending on the thickness of the coating, drying times of between 30 minutes through to several hours are needed. The suspension dryer here is divided into a plurality of drying zones, in which different temperatures may be set.

The drying rate is generally a function of the drying temperature and the air velocity, where the latter is distributed uniformly over the drying material.

There are suspension dryers known in which above the moving web of support rods moved by the dryer, via which the material web is hung in festoons, there are fixed nozzles for the supply of drying air, through which the drying air is directed alternately into the interstices and onto the region of the material web which lies directly on the support rods. For the supply of drying air, two supply ducts extending in the longitudinal direction of the dryer are provided above the fixed nozzles.

In another known suspension dryer, in which the drying air is passed into the festoons, each festoon limb of each hanging festoon is assigned at least one nozzle which is set with an incline—that is, obliquely—at an acute angle to the associated festoon of material web. The arrangement selected for the nozzles is such that the drying air is directed directly onto the material web essentially in the region of the support rods or shortly below.

Further variants of suspension dryers are known from DE 24 27 355 A1 and DE 16 29 026.

Customary drying methods and drying technologies, particularly for PSAs, are described comprehensively in D. Satas, Handbook of Pressure Sensitive Adhesive Technology, 1999, “Drying” chapter, page 937 ff.

The production of thin coats of solvent-based or water-based materials with the technologies described can be taken as prior art. The production of corresponding products causes no problems at all to a person skilled in the art.

The production of thick coats of solvent-based materials is frequently of less economic interest owing to the necessary laminating operations.

In contrast there is great interest in the production of thick, water-based coats, particularly for the production of pressure-sensitive adhesive tapes with a high adhesive coatweight.

Taking account of the customary technologies and units described, the production of single-ply thick coats of an aqueously dispersed composition is not sufficiently successful, since the number and length of the drying tunnels are inadequate to displace the water from the coating and to realize a filming operation which is homogeneous over the coat thickness.

### BRIEF SUMMARY OF THE INVENTION

It is an object of the invention to remedy this situation and to provide a method which does not have the deficiencies described, or has them only to a minor extent.

This object is achieved by means of a method of coating a web-form carrier material with an aqueously dispersed composition. The dependent claims provide advantageous developments of the subject matter of the invention. Additionally embraced by the concept of the invention are the products produced by this method.

The invention accordingly provides a method of coating a web-form carrier material with an aqueously dispersed composition, the composition being applied to the carrier material with a suitable applicator with a coatweight of at least 10 g/m² (dry) and the subsequent drying of the coated carrier material taking place in a suspension drying unit. Suspension drying, as a downstream drying technology for vacuum drying, is an established drying method from leather production. For the drying of water-based adhesive and non-adhesive coatings, however, this technology is innovative and entirely unknown.

The coatweight of the adhesive or non-adhesive coating on the web-form carrier material may be between 10 and 1000 g/m² (dry), preferably between 20 and 300 g/m² (dry). Preference is further given to coatweights greater than 150 g/m² (dry) and/or up to 300 g/m² (dry), particularly between 190 g/m² and 220 g/m² (dry).

The figures stated also correspond here approximately to the thickness in pm of the resulting coat of composition.

Preferred for the coatings are compounded formulations or scaffold polymers in dispersion in water, as a composition, with a high solids content and a relatively high viscosity, in order to prevent the coated material from running from the carrier material in festoons in the suspension drying unit. The water-based scaffold polymers or the corresponding compounded formulations can also be modified with standard commercial synthetic or natural thickeners, so that the viscosity thus modified conforms to the technical requirements of the method.

The viscosities of the aqueously dispersed scaffold polymers or of the corresponding compounded formulations are situated in a range between 0.001 Pa*s and 1000 Pa*s, preferably between 0.1 Pa*s and 100 Pa*s, measured at room temperature and at a shear rate of 100 s⁻¹.

The solids contents of the dispersions of scaffold polymers or of the corresponding compounded formulations that are to be coated are situated in a range between 25% and 75% by weight, preferably between 50% and 70% by weight.

The composition to be applied may take the form of a primary or secondary dispersion.

Primary dispersions (latices) are polymer dispersions prepared by emulsion polymerization. In this case the monomers are polymerized in the presence of an emulsifier in an aqueous medium.

Secondary dispersions are formed from polymers which are prepared conventionally and then in a subsequent step, from solution or the melt, are converted into the aqueous dispersion.

Coating takes place preferably of adhesive, aqueously dispersed scaffold polymers or oligomers, in pure form or as a compounded formulation, which may have been blended with tackifier resins, plasticizer resins, ageing inhibitors, rubbers, fillers, flame retardants, oils, emulsifiers or further additives.

Examples of water-based scaffold polymers which can be used include polyacrylic esters, copolymers of polyacrylic ester and acrylic acid, styrene-butadienes, styrene-acrylates, butadiene-acrylates, butadiene-methacrylates, butadiene-methyl methacrylates, polyvinyl acetate-styrene acrylates, ethylene-vinyl acetate-acrylates, acrylonitrile-butadienes, acrylonitrile-butadiene-styrenes, polyvinyl acetates, polyvinyl acetate-acrylates, vinyl acetate-vinyl chloride-ethylene-acrylates, vinyl acetate-vinyl chloride-ethylenes, vinyl acetate-Versatate copolymers, vinyl acetate-maleic esters, polychloroprenes, polyester resins, polyurethanes, polyurethane-acrylates, epoxy-polyurethane, polyurethane-epoxy-acrylates, polyethylenes and polypropylenes, polyvinyl chlorides and copolymers thereof.

Additionally it is possible to use natural rubber latex and further water-based synthetic rubbers in pure form or as a compounded formulation with other synthetic rubbers.

Water-based styrene block copolymers based on styrene-isoprene-styrene, styrene-butadiene-styrene, styrene-ethylene-butadiene-styrene, styrene-butadiene-butylene-styrene, styrene-ethylene-propylene-styrene and further copolymers are likewise suitable as scaffold polymers.

It is preferred if the coated composition can be crosslinked chemically by radiation, in particular by electron beams.

A preferred carrier is a film, a paper or a woven fabric to which the coating is applied on one side.

The films are essentially polyethylene, polypropylene, polyamide, polyester, polyethylene terephthalate, polyvinyl chloride and other polymers and copolymers customary for use as adhesive tape carriers, and may be used in both single-layer and multi-layer form. In the case of multi-layer systems, it is also possible for the composition and the thickness of the individual layers to vary.

Monoaxially and biaxially oriented polypropylenes are frequently employed for applications where a defined tensile strength is of not inconsiderable importance.

Monoaxially oriented polypropylenes exhibit particularly good tensile strength and low stretch in machine direction. In order to obtain uniform strength values in machine and cross directions, films must be oriented biaxially.

Both monoaxially and biaxially oriented polypropylenes and polyethylenes are particularly suitable carrier materials. The draw ratios are guided in this case by the corresponding requirements.

Both blown films and flat films can be used.

In order to ensure sufficient adhesion of the adhesive, selected preferably as the composition, to the carrier material, the surface energy of the side to be coated ought to be situated within a defined range. This can be ensured either via additional coating with primer or via a surface treatment. Preference is given to a corona pretreatment or flame pretreatment allowing the desired surface energies to be achieved. The surface energy ought to be situated within a range from ≧25 to 50 mN/m, preferably ≧30 to 45 mN/m.

As carrier material it is further possible to use all known textile carriers such as a loop product or a velour, scrim, woven or knit, a PET filament woven or a nylon woven, or a nonwoven web; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics are matlike layer structures comprising a cover layer of a fibre or filament fleece, an underlayer and individual retaining fibres or bundles of such fibres between these layers, said fibres being distributed over the area of the layer structure, being needled through the particle layer, and joining the cover layer and the underlayer to one another. The retaining fibres needled through the particle layer hold the cover layer and the underlayer at a distance from one another and are joined to the cover layer and the underlayer.

Suitable nonwovens include, in particular, consolidated staple fibre webs, but also filament webs, meltblown webs, and spunbonded webs, which generally require additional consolidation. Known possible consolidation methods for webs are mechanical, thermal, and chemical consolidation. Whereas with mechanical consolidations the fibres are mostly held together purely mechanically by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to the fibre nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained from sources including the companies Naue Fasertechnik and Techtex GmbH.

A Malifleece is characterized in that a cross-laid web is consolidated by the formation of loops from fibres of the web.

The carrier used may also be a web of the Kunit or Multiknit type. A Kunit web is characterized in that it originates from the processing of a longitudinally oriented fibre web to form a sheetlike structure which has loops on one side and, on the other, loop feet or pile fibre folds, but possesses neither threads nor prefabricated sheetlike structures. A web of this kind, too, has been produced, for a relatively long time, for example on stitchbonding machines of the “Kunitvlies” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching.

Finally, stitchbonded webs are also suitable as an intermediate to form an inventive adhesive tape. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

And then the Caliweb® is outstandingly suitable. The Caliweb® consists of a thermally fixed Multiknit spacer web with two outer mesh layers and an inner pile layer, which is arranged perpendicular to the mesh layers.

Also particularly advantageous is a staple fibre web which is mechanically preconsolidated in the first step or is a wet-laid web laid hydrodynamically, in which between 2% and 50% of the web fibres are fusible fibres, more particularly between 5% and 40% of the fibres of the web.

A web of this kind is characterized in that the fibres are laid wet or, for example, a staple fibre web is preconsolidated by the formation of loops from fibres of the web or by needling, stitching or air-jet and/or water-jet treatment.

In a second step, thermofixing takes place, with the strength of the web being increased again by the complete or partial melting of the fusible fibres.

The web carrier may also be consolidated without binders, by means for example of hot embossing with structured rollers, in which case pressure, temperature, dwell time, and embossing geometry can be used to control properties like strength, thickness, density, flexibility and the like.

Starting materials envisaged for the textile carriers include, in particular, polyester, polypropylene, viscose or cotton fibres. The selection is, however, not restricted to the stated materials; rather it is possible to use a large number of other fibres to produce the web, this being evident to a person skilled in the art, without any need for inventive activity. Used in particular are wear-resistant polymers such as polyesters, polyolefins, polyamides or fibres of glass or of carbon.

Also suitable as carrier material are carriers comprising impregnated or highly sized paper (creped and/or uncreped), comprising a laminate or comprising web-form foams (of polyethylene and polyurethane, for example).

Depending on the desired application, papers with higher machine-direction extensibility than cross-direction extensibility, and also papers with higher cross-direction extensibility than machine-direction extensibility, may be used, both in the bleached version and in the eco-friendly unbleached version.

On the coating side it is possible for the surfaces of the carriers to have been chemically or physically pretreated, and also for their reverse side to have been subjected to an anti-adhesive physical treatment or coating.

Finally, the web-form carrier material may be a double-sidedly anti-adhesively coated material such as a release paper or a release film, also called liner or release material, if the coat of adhesive, in particular after crosslinking, is to be used as a carrierless, double-sided self-adhesive tape.

With particular advantage, therefore, the method is suitable for producing pressure-sensitive adhesive tapes by application of pressure-sensitive adhesives to carrier materials on one or both sides.

A suitable unit for performing the method of the invention consists of a coating station to be selected as a function of the viscosity of the composition to be coated, preferably a knife metering system or coating bar with comma knife or coating blade, which may be followed preferably by a horizontally disposed preliminary drying tunnel, in particular an infrared dryer. Preliminary drying makes it possible to ensure that the coating is altered in its viscosity to an extent such that it is unable to run from the carrier material.

Corona pretreatment of the carrier material may take place upstream of the applicator.

After the preliminary dryer, where present, the coated carrier material is introduced into a suspension dryer having a plurality of drying zones, preferably around ten, with different drying temperatures, preferably between 30° C. and 70° C.

In accordance with a further advantageous embodiment, the drying tunnels may be followed by electron-beam or UV curing, which allows the cohesion of the coating to be influenced.

After the suspension drying and after the electron-beam or UV curing, where present, a carrier can be laminated on via a laminator.

This carrier may be an anti-adhesively treated carrier material. If coating takes place on an anti-adhesively treated carrier material, it is also possible for a non-anti-adhesively treated carrier to be laminated on in the laminator.

The carrier material introduced into the suspension unit for drying may have a length of 50 to 5000 m, preferably 500 to 2000 m. The residence time in the suspension unit, as a function of the speed, is preferably 0.2 to 5 hours, more preferably 0.5 to 2 hours. Customary coating speeds are situated within a range between 5 and 500 m/min, preferably 20 and 200 m/min.

The method of the invention is preferably carried out continuously in one operation.

### EXAMPLES

Examples below are intended to illustrate the invention without restricting its scope:

### Test Methods

### Holding Powers

The test takes place along the lines of PSTC-7. A strip of the pressure-sensitive adhesive tape, 1.3 cm wide, is adhered over a length of 2 cm to a polished steel plaque and rolled over back and forth twice with a 2 kg roller. This corresponds to a bond area of 260 mm². The plaques are equilibrated for 30 minutes under test conditions (temperature and air humidity) but without loading. Then the test weight is hung on (1 kg, for example), producing a shearing stress parallel to the bond area, and a measurement is made of the time until the bond fails. Where a holding power of 10 000 minutes is reached, the test is discontinued before the failure of the bond.

### Dynamic Viscosity Measurement

The viscosity measurement of the coating composition is carried out with a Rheometrics ARES at room temperature or 40° C. and at a shear rate of 100 s⁻¹ using a cone/plate system with a diameter of 50 mm.

### Bond Strengths

The bond strengths are determined on test strips which (as far as possible) are 20 mm wide, in accordance with AFERA 4001, with a peel angle of 180°. In these tests, the test substrates used are steel plates in accordance with the AFERA standard. In a variant, polyethylene is employed as a test substrate.

### Example 1

Acronal V205 (aqueous dispersion of a carboxyl-containing acrylic ester copolymer based on butyl acrylate, with a solids content of 69% by weight, BASF) is mixed with 0.3% by weight (based on solids content) of Latekoll D (dispersion of a carboxyl-containing acrylic ester copolymer in water, BASF), a thickener. The compounded formulation thus obtained is rendered slightly alkaline with ammonia, so that the thickening properties of Latekoll D take effect.

The resulting dispersion-based pressure-sensitive adhesive is coated using a coating blade having a slot of 50 μm onto a corona-pretreated polyethylene terephthalate film having a thickness of 25 μm, with a coat thickness of 250 g/m² (dry).

The coated material is introduced into a preliminary drying tunnel and dried with an infrared source.

This is followed by the main drying operation in a suspension dryer having different drying zones. Following the main drying, the coated material is introduced into an electron-beam curing unit. The material thus crosslinked is then laminated with siliconized release paper and wound up to form a roll.

Technical conditions

| | |
|---|---|
| Machine: | production coating unit |
| Carrier web speed: | 50 m/min |
| Tension force, unwinder: | 600 N |
| Applicator: | coating table with coating blade |

| | |
|---|---|
| Drying: | Preliminary drying infrared |
| | Main drying: Suspension drying |
| | with ten drying zones |
| | Zone 1 30° C. |
| | Zone 2 30° C. |
| | Zone 3 40° C. |
| | Zone 4 40° C. |
| | Zone 5 50° C. |
| | Zone 6 50° C. |
| | Zone 7 60° C. |
| | Zone 8 70° C. |
| | Zone 9 70° C. |
| | Zone 10 50° C. |

| | | |
|---|---|---|
| Crosslinking: | Acceleration voltage: | 230 kV |
| | Dose: | 10 kGy |

Technical Adhesive Data:

Bond strength to steel (300 mm/min): 7.5 N/cm

Bond strength to polyethylene (30 mm/min): 4.2 N/cm

Holding power at room temperature (RT) (1 kg/260 mm²): 55 min

Holding power at 40° C. (1 kg/260 mm²): 36 min

### Example 2

Polytex WP 5000 (aqueous dispersion of a carboxyl-containing acrylic ester copolymer, with a solids content of 65% by weight, Avery Dennison) is mixed with 0.3% by weight (based on solids content) of Latekoll D. The compounded formulation thus obtained is rendered slightly alkaline with ammonia, so that the thickening properties of Latekoll D take effect.

The resulting dispersion-based pressure-sensitive adhesive is coated using a coating blade having a slot of 65 pm onto a siliconized release paper, with a coat thickness of 220 g/m² (dry). This is followed by the main drying operation in a suspension dryer having different drying zones. The main drying is followed by a laminating operation in which a corona-pretreated polyethylene terephthalate film 25 μm thick is laminated on. The laminated material is wound up to form a roll.

Technical conditions

| | |
|---|---|
| Machine: | production coating unit |
| Carrier web speed: | 60 m/min |
| Tension force, unwinder: | 600 N |
| Applicator: | coating table with coating blade |

| | |
|---|---|
| Drying: | Preliminary drying infrared |
| | Main drying: Suspension drying with ten |
| | drying zones |
| | Zone 1 30° C. |
| | Zone 2 30° C. |
| | Zone 3 40° C. |
| | Zone 4 40° C. |
| | Zone 5 50° C. |
| | Zone 6 50° C. |
| | Zone 7 60° C. |
| | Zone 8 70° C. |
| | Zone 9 70° C. |
| | Zone 10 50° C. |

Technical Adhesive Data:

Bond strength to steel (300 mm/min): 12 N/cm

Bond strength to polyethylene (30 mm/min): 5.5 N/cm

Holding power at RT (1 kg/260 mm²): 29 min

Holding power at 40° C. (1 kg/260 mm²): 7 min

### Example 3

Orgal AX 1203 (polyacrylate dispersion based on butyl acrylate, with a solids content of 67% by weight, Organik Kimya) is mixed with 0.3% by weight (based on solids content) of Collacral HP (aqueous solution of a copolymer based on acrylic acid and acrylamide, emulsified in aliphatic mineral-oil fraction, with a solids content of 29% by weight, BASF). The dispersion-based pressure-sensitive adhesive thus obtained is coated using a coating blade with a slot of 80 μm onto a corona-pretreated polyethylene terephthalate film 25 μm thick, with a coat thickness of 400 g/m² (dry). The coated material is introduced into a preliminary drying tunnel and dried with an infrared source. This is followed by the main drying operation in a suspension dryer having different drying zones. The coated material is subsequently laminated with siliconized release paper and wound up to form a roll.

Technical conditions

| | |
|---|---|
| Machine: | production coating unit |
| Carrier web speed: | 60 m/min |
| Tension force, unwinder: | 600 N |
| Applicator: | coating table with coating blade |

| | |
|---|---|
| Drying: | Preliminary drying infrared |
| | Main drying: Suspension drying with ten |
| | drying zones |
| | Zone 1 30° C. |
| | Zone 2 30° C. |
| | Zone 3 40° C. |
| | Zone 4 40° C. |
| | Zone 5 50° C. |
| | Zone 6 50° C. |
| | Zone 7 60° C. |
| | Zone 8 70° C. |
| | Zone 9 70° C. |
| | Zone 10 50° C. |

Technical Adhesive Data:

Bond strength to steel (300 mm/min): 6.6 N/cm

Bond strength to polyethylene (30 mm/min): 4.5 N/cm

Holding power at RT (1 kg/260 mm²): 687 min

Holding power at 40° C. (1 kg/260 mm²): 11 min

1. A method of coating a web-form carrier material with an aqueously dispersed composition comprising the steps of
applying the composition to the carrier material with an applicator with a coatweight of at least 10 g/m² (dry) and
subsequently drying the coated carrier material in a suspension drying unit.

2. The method according to claim 1, wherein the composition to be applied is an adhesive.

3. The method according to claim 1, wherein the coatweight on the carrier material is between 10 and 1000 g/m² (dry).

4. The method according to claim 3, wherein the coatweight on the carrier material is between 20 and 300 g/m² (dry).

5. The method according to claim 1, wherein the dispersed composition has a viscosity between 0.001 Pa*s and 1000 Pa*s, measured at room temperature and a shear rate of 100 s⁻¹, and the solids content of the dispersed composition is in a range between 25% and 75% by weight.

6. The method according to claim 5, wherein the viscosity is between 0.1 Pa*s and 100 Pa*s, measured at room temperature and a shear rate of 100 s⁻¹, and the solids content of the dispersed composition is in a range between 25% and 75% by weight.

7. The method according to claim 6, wherein the viscosity is between 0.1 Pa*s and 100 Pa*s, measured at room temperature and a shear rate of 100 s⁻¹, and the solids content of the dispersed composition is in a range between 50% and 70% by weight.

8. The method according to at claim 1, further providing the step of thickening the composition prior to coating.

9. The method according to claim 1, further including the step of physically crosslinking the coated composition.

10. The method according to claim 9, wherein the crosslinking is accomplished by electron beams

11. The method according to claim 1, wherein the carrier material is at least one of a film, a paper, a woven fabric or a nonwoven or an anti-adhesively treated carrier.

12. The method according to claim 1, wherein the applicator is one of a knife metering system, a coating bar with comma knife or a coating blade.

13. The method according to claim 1, further providing, between the applying step and the drying step, a horizontally disposed preliminary drying tunnel.

14. The method according to claim 13, wherein the preliminary drying tunnel is an infrared dryer.

15. The method according claim 1, further comprising the step of corona treating the carrier material which takes place upstream of the applicator.

16. The method according to claim 1, further providing the step of providing electron-beam or UV curing of the composition downstream of the suspension drying.

17. The method according to claim 16, wherein the carrier is being laminated via a laminator downstream of the suspension drying and the electron-beam or UV curing.

18. The method according to claim 1, further providing the step of applying pressure-sensitive adhesives to the carrier materials on one or both sides to produce pressure-sensitive adhesive tapes.
